(19) United States
(12) Patent Application Publication
(10) Pub. No.: US 2009/0092370 A1
(43) Pub. Date: Apr. 9, 2009

(54) Electronic device and method for displaying an error state

(75) Inventor: Hirofumi Murakami, Kanagawa (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 12/286,366

(22) Filed: Sep. 30, 2008

(30) Foreign Application Priority Data
Oct. 4, 2007 (JP) P2007-261348

(51) Int. Cl. H04N 5/94

(52) U.S. Cl. 386/51; 386/E05.035

(57) ABSTRACT

An electronic device of the present invention includes: an input signal alarm that detects an error state while video data is being recorded or reproduced; a TC generator that acquires a time counter value of the video data; and an alarm display manager that causes a recorder to record the information as to the last error state detected and the time counter value acquired when the error state is detected, the information and the time counter value being associated with each other.

### CROSS-REFERENCES TO RELATED APPLICATIONS

The present invention contains subject matter related to Japanese Patent Application JP2007-261348 filed in the Japan Patent Office on Oct. 4, 2007, the entire contents of which being incorporated herein by reference.

### BACKGROUND OF THE INVENTION

1. Field of the Invention

The present invention relates to an electronic device and a method for displaying an error state.

2. Description of the Related Art

In related art, the following Japanese Patent Application JP 11-249925 discloses a technique by which the contents of an error that occurs in an electronic device and the address of the memory that stores the contents of the operation performed immediately before the error occurrence are stored in an error history memory.

[Patent Document 1] Japanese Patent Application JP 11-249925

### SUMMARY OF THE INVENTION

When an error occurs in an electronic device, an alarm may be displayed to notify the user of the error occurrence. However, the alarm is erased after the operation returns to a normal state. Therefore, if the user does not look at the display screen while the alarm is displayed, the user misses the alarm display. If the alarm is displayed for a long period of time, however, the alarm remains on display even after the operation returns to the normal state, which causes an issue in operability.

When an error occurs during a video data recording/reproducing operation, the user can recognize the error occurrence through a displayed alarm. However, the user may not be able to recognize at which part of video data the error has occurred. Therefore, when there is a displayed alarm, the user needs to check at which part of the video data the error has occurred by reproducing all the recorded video data, and take the trouble to carry out very complicated procedures.

The present invention has been made in view of the above circumstances, and it is desirable to provide a novel and improved electronic device that can cause a user to recognize the information about an alarm and the corresponding video data even if the user misses the alarm display, and a method for displaying an error state.

According to an embodiment of the present invention, there is provided an electronic device that includes: an error detector that detects an error state while video data is being recorded or reproduced; a time counter value acquiring section that acquires the time counter value of the video data; and a record processor that causes a recorder to record the information as to the error state and the time counter value acquired when the error state is detected, the information and the time counter value being associated with each other.

With this structure, an error state is detected while video data is being recorded or reproduced, and the time counter value of the video data is obtained. The information as to the error state is associated with the time counter value obtained at the time of detection of the error state, and is then recorded. Accordingly, the error state and the time counter value can be obtained at the same time, and the user can recognize at which part of the video data the error has occurred.

The electronic device may further include a display processor that acquires the information as to the last error state detected and the corresponding time counter value from the recorder, and performs display processing so as to display the information and the time counter value on a display. With this structure, the information as to the last error state detected and the corresponding time counter value are displayed. Accordingly, it is possible to recognize the last detected error and the corresponding time counter value, based on the display.

The record processor may record time information as to the detection of the error state in association with the information as to the error state and the time counter value. With this structure, the time information as to the detection of the error state can be recorded in association with the information as to the error state and the corresponding time counter value. Accordingly, it is possible to recognize the last detected error together with the time counter value and the time information.

According to another embodiment of the present invention, there is provided a method for displaying an error state that includes the steps of: detecting an error state while video data is being recorded or reproduced; acquiring the time counter value of the video data; recording the information as to the error state in association with the time counter value acquired when the error state is detected; and reading the information as to the last error state detected and the time counter value associated with the information, and displaying the information and the time counter value on a display.

With this structure, an error state is detected while video data is being recorded or reproduced, and the time counter value of the video data is obtained. The information as to the error state is associated with the time counter value obtained at the time of the detection of the error state, and is then recorded. The information as to the last error state detected and the corresponding time counter value are read at the same time, and are displayed on the display. Accordingly, it is possible to recognize the last detected error together with the corresponding time counter value, and also recognize at which part of the video data the error has occurred.

In the step of recording the information as to the error state, the time information as to the detection of the error state may be recorded in association with the information as to the error state and the time counter value, and, in the step of displaying, the time information as well as information as to the last error state detected and the time counter value may be displayed on the display. With this structure, it is possible to recognize the last detected error together with the corresponding time counter value and time information.

### BRIEF DESCRIPTION OF THE DRAWINGS

FIG. 1 is an external perspective view of a record reproduction device according to an embodiment of the present invention;

FIG. 2 is a block diagram schematically illustrating the internal structure of the record reproduction device shown in FIG. 1;

FIG. 3 is a functional block diagram illustrating the controller shown in FIG. 1 and its peripheral structures;

FIGS. 4A and 4B are schematic views of a display screen on a display of the record reproduction device according to the embodiment;

FIGS. 5A and 5B are schematic views of a display screen on the display of the record reproduction device according to the embodiment;

FIGS. 6A, 6B and 6C are schematic views of a display screen on the display of the record reproduction device according to the embodiment; and

FIGS. 7 7A, 7B and 7C are schematic views of a display screen on the display of the record reproduction device according to the embodiment.

### DETAILED DESCRIPTION OF THE PREFERRED EMBODIMENTS

Hereinafter, preferred embodiments of the present invention will be described in detail with reference to the appended drawings. Note that, in this specification and the appended drawings, structural elements that have substantially the same function and structure are denoted with the same reference numerals, and repeated explanation of these structural elements is omitted.

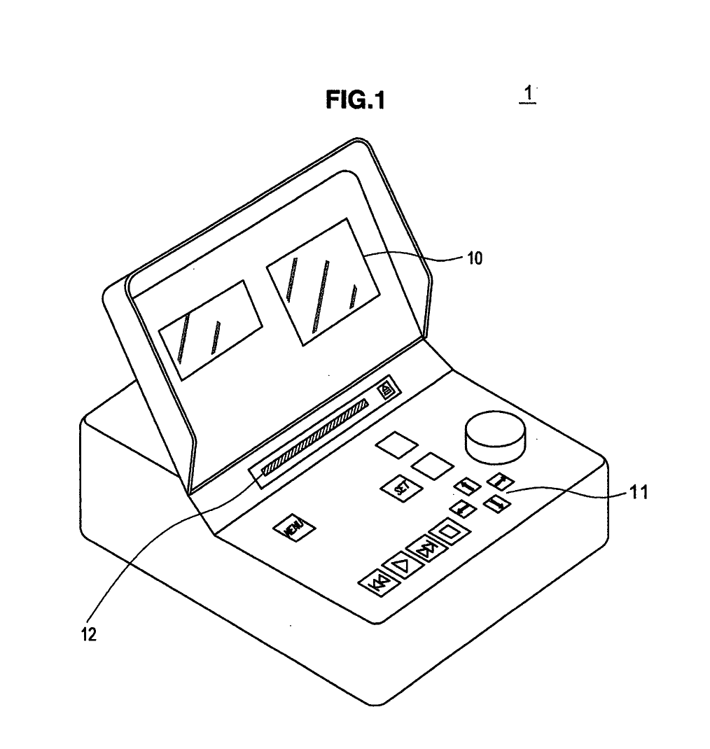

FIG. 1 is an external perspective view of a record reproduction device (an electronic device) 1 according to an embodiment of the present invention. This record reproduction device 1 is a professional-use portable video editing device that is designed for television broadcasting companies and program producing companies to edit video images taken on the set or the like. For example, the record reproduction device 1 is loaded with an optical disc as a recording medium, and the video data recorded on the optical disc is edited. The record reproduction device 1 according to this embodiment is not limited to the structure illustrated in FIG. 1, but may be used in a wide variety of devices that perform record reproduction on media such as optical discs.

This record reproduction device 1 includes a disc loading unit 12 to be loaded with an optical disc, as shown in FIG. 1. The record reproduction device 1 also includes a display 10 that displays video images and the likes reproduced from the optical disc. The record reproduction device 1 further includes operating parts (such as operation keys and operation dials) as an operation unit 11 designed for users to input information and operations.

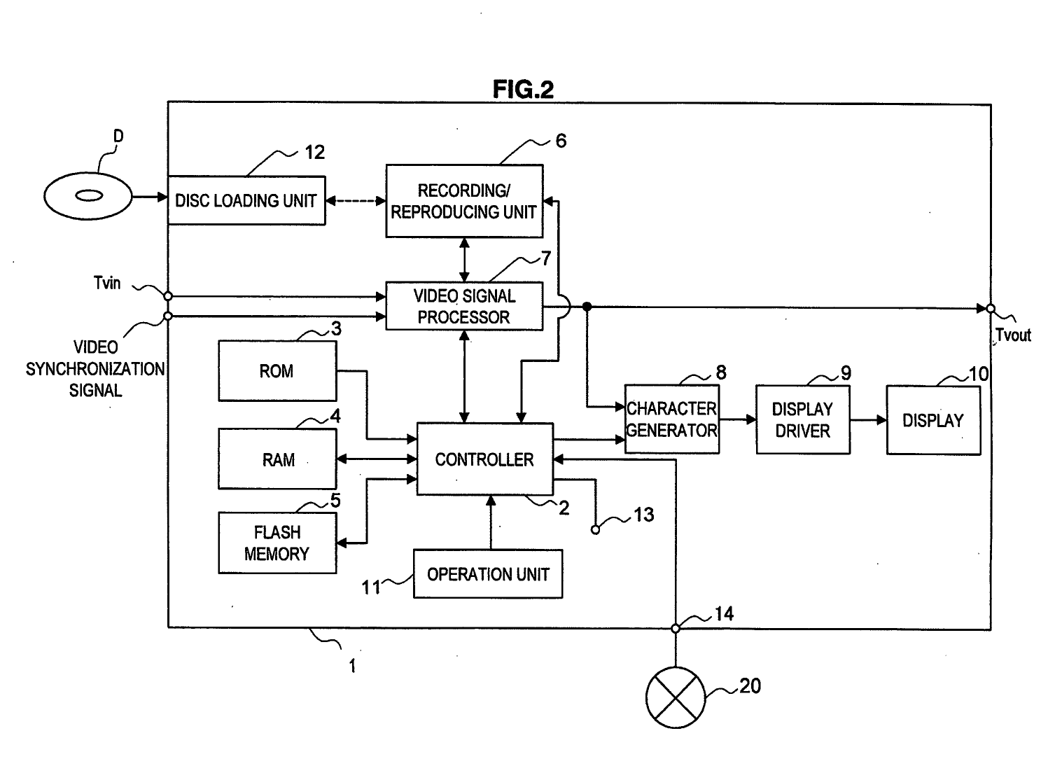

FIG. 2 is a block diagram schematically showing the internal structure of the record reproduction device 1 illustrated in FIG. 1. The disc loading unit 12 is loaded with an optical disc D. On the optical disc D, recording or reproduction is performed with a laser wavelength λ of 405 nm and NA (number of apertures) of 0.85. The optical disc D has a phase-change film as a recording film, so that data rewriting can be performed. The recording capacity is approximately 23 GB (gigabytes), which is relatively large. Accordingly, the optical disc D can be used to record high-resolution video images for professional use. The data recorded on the optical disc D is mostly video data (image data).

A recording/reproducing unit 6 performs recording and reproduction on the optical disc D inserted to the disc loading unit 12. The recording/reproducing unit 6 as a structure to record and reproduce the data recorded on the optical disc D includes an optical head, a spindle motor, a servo circuit, a decoder for obtaining reproduction data, and an encoder for generating recording data. The data reproduced from the inserted optical disc D is sent from the recording/reproducing unit 6 to a video signal processor 7. The data to be recorded on the optical disc D is input from the video signal processor 7 to the recording/reproducing unit 6.

It is possible to input video data from a video input terminal Tvin (which might include audio data), as well as video data reproduced from the optical disc D by the recording/reproducing unit 6, to the video signal processor 7. A video synchronization signal (a reference signal) for maintaining video synchronization is also input to the video signal processor 7. The video signal processor 7 is designed to perform various kinds of video signal processing (image signal processing) on input video data. For example, the video signal processor 7 performs video level adjustment, chrome level adjustment, setup level adjustment, chrome phase adjustment, system phase adjustment, synchronization phase adjustment, and the likes. Based on a setting value supplied from a controller 2 (described later) for each adjustment process, the video signal processor 7 performs the above signal processing.

The output of the video signal processor 7 is supplied to a video output terminal Tvout, and also to a character generator 8. The character generator 8 is designed to generate and superimpose characters, icons, and the likes on input video data. For example, the character generator 8 generates character data as a GUI (Graphical User Interface) to be used by a user to adjust the setting value for each of the signal processing operations to be performed by the video signal processor 7. The character generator 8 can superimpose character data on video data, so that characters can be superimposed on a video image displayed on the background based on the output from the video signal processor 7. Alternatively, the character generator 8 can generate image data, so that only characters are displayed. Further, the character generator 8 may output characters but may not impose the characters on the output from the video signal processor 7. The character generator 8 switches those operations in accordance with an instruction from the controller 2.

The output data from the character generator 8 is supplied to a display driver 9. The display driver 9 drives the display 10 such as a liquid crystal display, based on the data input from the character generator 8. In this manner, the display 10 displays a video image based on the output (video or image data) from the character generator 8.

The controller 2 is formed with a microcomputer that includes a CPU (Central Processing Unit), a memory area, an interface unit, and the likes. According to an activated program, the controller 2 controls the entire record reproduction device 1 and performs operations of the record reproduction device 1. For example, the controller 2 controls operations according to an operation input through an operation unit 11, recording/reproducing operations or access operations on the optical disc D inserted to the disc loading unit 12, and the likes. In a case where a user issues a reproducing instruction with respect to the optical disc D through the operating unit 11, the controller 2 instructs the recording/reproducing unit 6 to reproduce the optical disc D. The recording/reproducing unit 6 in turn performs an access operation or a reproducing operation on the optical disc D, and the reproduction data obtained here is supplied to the video signal processor 7. The reproduction data (video data) supplied to the video signal processor 7 is subjected to video signal processing, if necessary, and is then supplied to the character generator 8. In a regular reproducing operation, the controller 2 instructs beforehand the character generator 8 to output the video data as it is. The video data output from the character generator 8 is supplied to the display driver 9. Based on the video data, the display driver 9 controls the driving of the display 10. In this manner, video display based on video data reproduced from the optical disc D is performed.

The memories to be accessed by the controller 2 include a ROM (Reed Only Memory) 3, a RAM (Random Access Memory) 4, and a flash memory 5, for example. The operation program and the program loader of the controller 2 and the likes are stored in the ROM 3. The data area and task area to be used by the controller 2 in executing a program are temporarily stored in the RAM 4. The flash memory 5 is a nonvolatile memory that allows data rewriting and stores recorded data after the power is switched off. For example, operation coefficients, parameters to be used in programs, and the likes are stored in the flash memory 5.

A terminal 13 is a RS232C standard connecting terminal that is provided inside a housing or the like. The terminal 13 is used in special-purpose operations such as device maintenance and repair. A terminal 14 is a terminal to establish a connection with a network 20 such as the Internet. A connection with the network 20 may be a wire connection with the use of a communication cable connected to the terminal 14. However, it is possible to provide a wireless communication unit in place of the terminal 14, so as to establish a connection with the network 20 in a wireless manner.

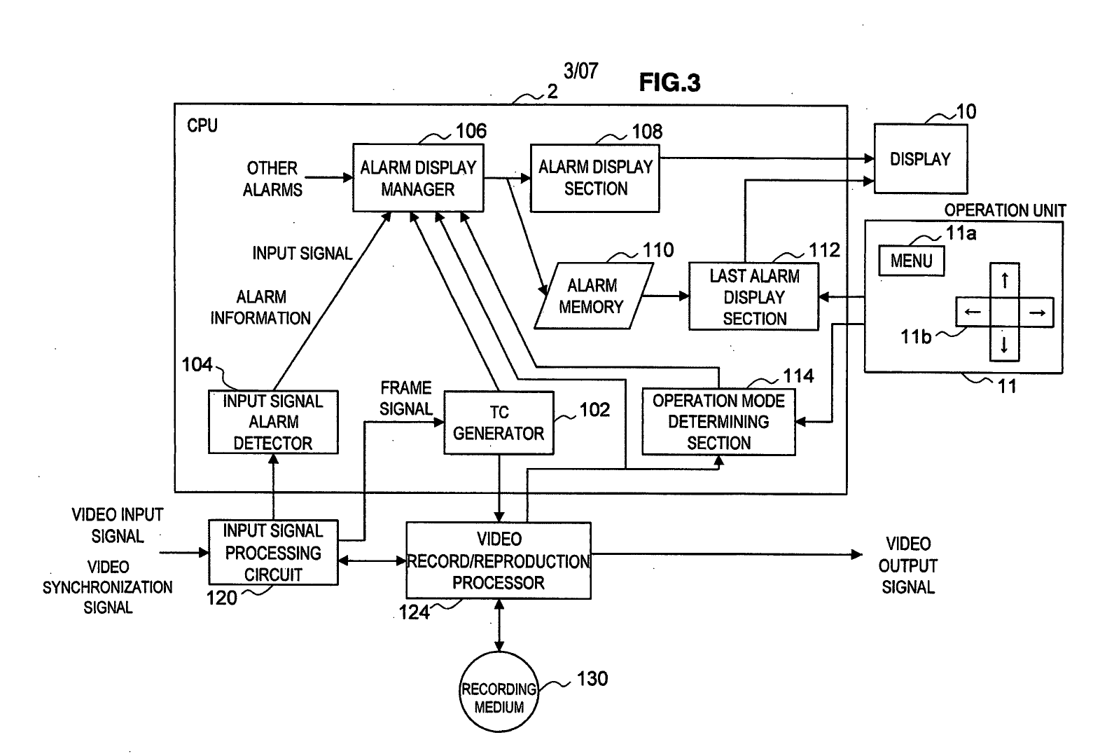

FIG. 3 is a functional block diagram of the controller 2 shown in FIG. 1 and its peripheral structures. In FIG. 3, an input signal processing circuit 120 is equivalent to a portion of the video signal processor 7 shown in FIG. 2, and a video record/reproduction processor 124 is equivalent to a portion of the recording/reproducing unit 6 shown in FIG. 2. A recording medium 130 is equivalent to the optical disc D. As well as video data from the recording/reproducing unit 6, video data and a video synchronization signal from the outside are input to the input signal processing circuit 120. The respective blocks such as an input signal alarm detector 104 and an alarm display manager 106 shown in FIG. 3 are functional blocks for displaying an alarm (a warning) on the display 10 when an error occurs.

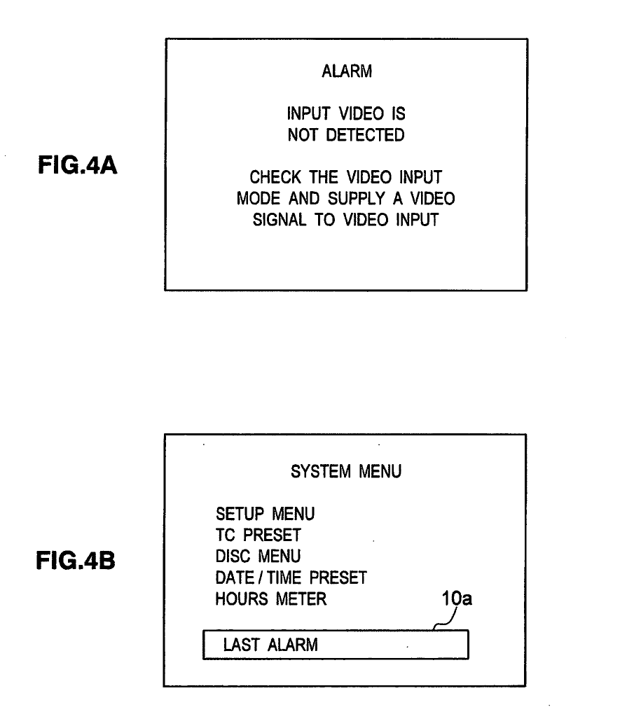

The last alarm display according to this embodiment is now described before each of the blocks shown in FIG. 3 is explained. FIG. 4A through 7C are schematic views of display screens displayed on the display 10 of the record reproduction device 1 according to this embodiment. When an error is detected, the record reproduction device 1 according to this embodiment displays the error occurrence on the display 10, so as to notify the user of the error occurrence.

An error state to be displayed may be an error related to a signal such as an input signal, an error related to an operation of the record reproduction device 1, an error related to an operation input by a user, or the like. An error related to a signal may occur in a case where disturbances are caused in an input signal and a video synchronization signal, or an input signal is lost, due to vibrations and the likes that are generated when the connection of a BNC cable to the video input terminal Tvin is an incomplete connection. Such vibrations do not cause issues in a regular state. An error related to an operation of the record reproduction device 1 may occur in a case where the servo lock of the optical pickup is disengaged when a further recording operation is performed after the optical disc D has reached its recording capacity. An error related to an operation may also occur in a case where a recording/reproducing signal is disturbed due to scratches on the surface of the optical disc D or dust or the like sticking to the surface of the optical disc D. An error related to an operation input by a user may occur in a case where a recording/reproducing operation is performed without insertion of the optical disc D or where an operation is performed through the operation panel in a remote mode.

Those errors are relatively small, and do not disable the record reproduction device 1. Therefore, if one of the above small errors occurs in the record reproduction device 1 according to this embodiment, a predetermined alarm is displayed on the display, so as to notify the user of the error occurrence.

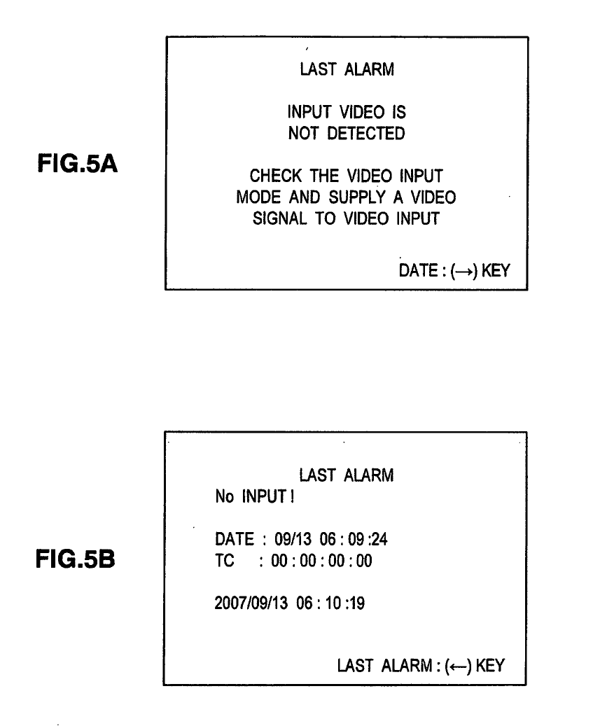

FIGS. 4A through 5B are schematic views of alarm notification screens displayed on the display 10. FIG. 4A shows a screen to be displayed on the display 10 for a predetermined period of time after an alarm occurs. In FIG. 4A, a message indicating that a video input has not been input to the video input terminal Tvin is displayed (“INPUT VIDEO IS NOT DETECTED”). For example, in a case where the connection of a connector to the video input terminal Tvin is an incomplete connection, and signal inputting is temporarily stopped due to vibrations or the likes, the display screen shown in FIG. 4A is displayed.

The display screen shown in FIG. 4A temporarily displays an alarm, and returns to normal display after the operation returns to a normal state. Therefore, if a user misses the alarm display, the user can hardly recognize the error about which the alarm has been issued.

To counter this issue, after the alarm display screen shown in FIG. 4A disappears, a predetermined operation is performed to display the last displayed alarm display screen in the record reproduction device 1 according to this embodiment.

FIG. 4B shows a menu screen to be displayed on the display 10. As shown in FIG. 4B, the menu screen displays various menus such as a setup menu (SETUP MENU), a time counter (TC) preset screen (TC PRESET). A menu (LAST ALARM) for displaying the last displayed alarm is displayed on the lowermost row. To display the last displayed alarm, a cursor 10a displayed on the display 10 is moved to the display position of “LAST ALARM”, and a return key “→” is pressed.

As a result, the display screen shown in FIG. 5A is displayed. The display screen shown in FIG. 5A is the last displayed alarm display screen, and corresponds to the alarm display screen shown in FIG. 4A. In this manner, by sending an instruction through the menu screen, the last alarm display screen can be displayed again.

When the key “→” of an operation button 11b of the operation unit 11 is pressed on the display screen shown in FIG. 5A, the screen is switched to the display screen shown in FIG. 5B. The display screen shown in FIG. 5B shows the details of the error corresponding to the last alarm display screen, and indicates the contents of the error (that there are no input signals “NO INPUT!”).

As shown in FIG. 5B, the date of the error occurrence “09/13 06:09:24”, and the value “00:00:00:00” of the time counter (TC), and the current date “2007/09/13 06:10:19” are displayed as well as the contents of the error “NO INPUT!”. Through the display, the user can recognize the date of the error occurrence and the value of the time counter at the time of the error occurrence. If the error shown in FIG. 4A occurs while video data is being recorded on the optical disc D, for example, the user can refer to the value of the time counter so as to recognize at which part of the recorded video the error occurs. When the key “←” of the operation button 11b on the display screen shown in FIG. 5B is pressed, the screen can return to the display screen shown in FIG. 5A.

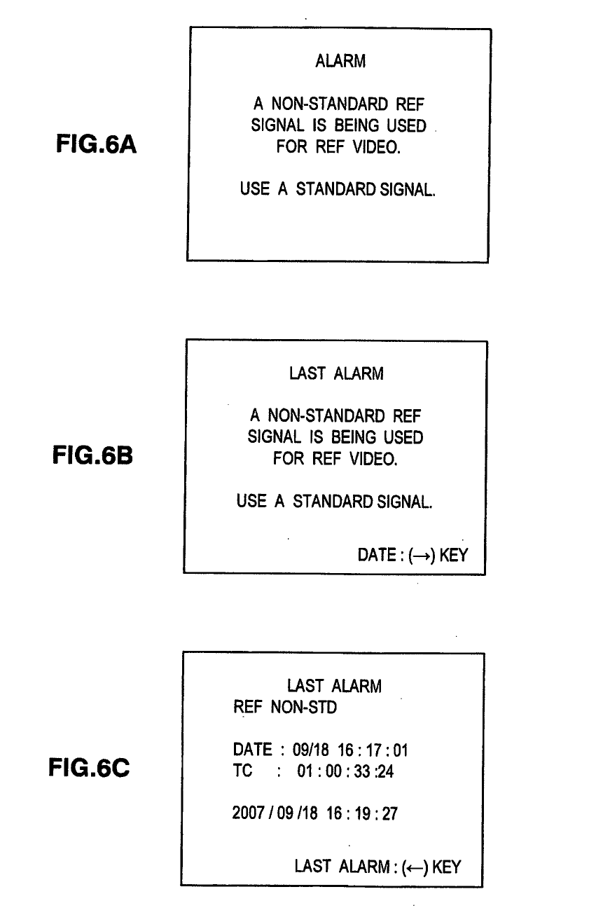

FIGS. 6A through 6C show display screens that are displayed when another error occurs, and indicate an alarm (“A NON-STANDARD REF SIGNAL IS BEING USED FOR REF VIDEO”) that is displayed when a different synchronization signal is used in a normal state. More specifically, FIG. 6A shows an alarm screen that is displayed when an error occurs. FIG. 6B shows a last alarm display screen that is displayed according to an operation through the menu screen. FIG. 6C shows a screen that is displayed by pressing the key “→” of the operation button 11b of the operation unit 11 through the display screen of FIG. 6B, and indicates the error occurrence date 2 “09/18 16:17:01”, the value of the time counter “01:00:33:24”, and the current date “2007/09/18 16:19:27”, as well as the error contents “REF NON-STD”.

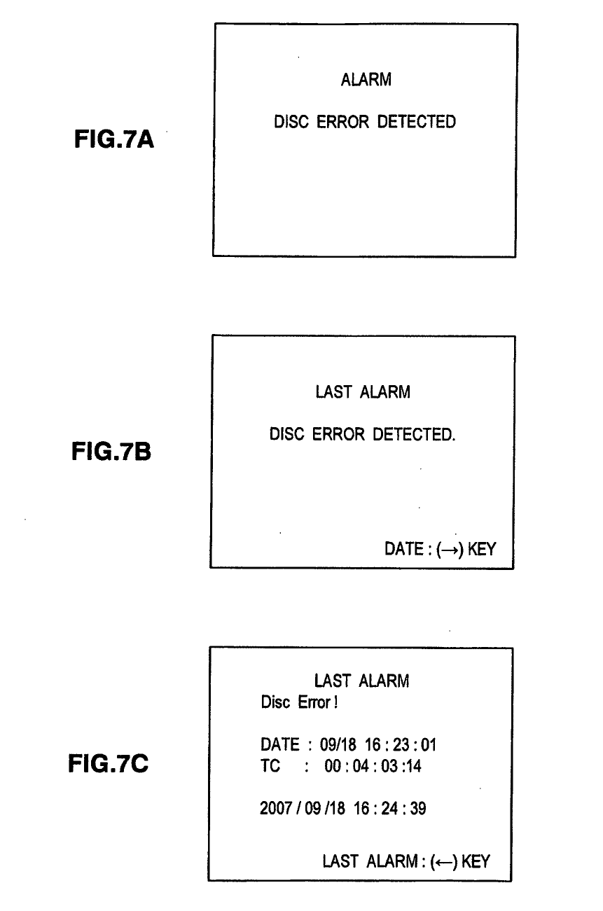

FIGS. 7A through 7C show display screens that are displayed when an error occurs in the optical disc D during a recording/reproducing operation, such as display screens that are displayed when a signal disturbance is detected due to scratches or dust on the surface of the optical disc D during a recording operation. More specifically, FIG. 7A shows a screen that is displayed when an error occurs, and indicates a message that the error is detected from the optical disc D (“DISC ERROR DETECTED”). FIG. 7B shows a last alarm display screen that is displayed according to an operation through the menu screen. FIG. 7C shows a screen that is displayed by pressing the key “→” of the operation button 11b of the operation unit 11 through the display screen of FIG. 7B, and indicates the error occurrence date “09/18 16:23:01”, the value of the time counter “00:04:03:14”, and the current date “2007/09/18 16:24:39”, as well as the error contents “Disc Error!”.

Referring back to FIG. 3, the structure for performing the last alarm display is now described. As well as video data from the video record/reproduction processor 124, video data from the video input terminal Tvin and a video synchronization signal are input to the input signal processing circuit 120.

As shown in FIG. 3, the controller 2 includes a TC generator 102, the input signal alarm detector 104, the alarm display manager 106, an alarm display section 108, an alarm memory 110, a last alarm display section 112, and an operation mode determining section 114.

The TC generator 102 provides a time counter (TC) value in synchronization with the frame signal to the video signal (frame signal) of each frame that is input to the input signal processing circuit 120. In a case where a time counter value has already been allotted to the video signal of each input frame, the TC generator 102 acquires the time counter value, and sends the time counter value to the alarm display manager 106.

In a case where an error occurs in a video input signal or a video synchronization signal that is input, the input signal alarm detector 104 sends the information about the error (input signal alarm information) to the alarm display manager 106, based on the video input signal or the video synchronization signal. The signal error may be a disturbance in an input video signal or input synchronization signal, or disappearance of such an input signal, for example.

In a case where an error occurs during a recording/reproducing operation, the video record/reproduction processor 124 sends the alarm information about the error occurrence to the alarm display manager 106. For example, when the optical disc D reaches its recording capacity during a recording operation, the alarm information is sent to the alarm display manager 106. The alarm display manager 106 associates the alarm information about the recording/reproduction with the corresponding time counter value, and sends the alarm information and the time counter value to the alarm display section 108 and the alarm memory 110.

Based on an input from the operation unit 11 and the contents of the processing performed by the video record/reproduction processor 124, the operation mode determining section 114 determines an operation mode in the record reproduction device 1. In a case where there is an error in the operation mode, the alarm information about the error is sent to the alarm display manager 106. For example, in a case where an instruction to perform recording/reproduction is input from the operation unit 11 while the optical disc D is not inserted to the disc loading unit 12, the alarm information to that effect is sent to the alarm display manager 106. The alarm display manager 106 associates an alarm about the operation with the corresponding time counter value, and sends the alarm and the time counter value to the alarm display section 108 and the alarm memory 110. In this manner, the video record/reproduction processor 124 and the operation mode determining section 114 function as an error detecting unit for detecting errors, like the input signal alarm detector 104.

The alarm display manager 106 constantly monitors alarm information. When alarm information is received, the alarm display manager 106 associates the alarm information with the time that corresponds to the alarm information and the corresponding time counter value, and sends the alarm information to the alarm display section 108 and the alarm memory 110. Here, the time counter value is a value that is input from the TC generator 102. The time is obtained from the clocks stored in the controller.

More specifically, when an alarm is issued, the alarm display manager 106 turns the contents of the alarm into an alarm code (ALARM CODE), and sends the error occurrence date (DATE) and the time counter value (TC) at the time of the error occurrence to the alarm display section 108. The set of ALARM CODE/DATE/TC data is stored in the alarm memory 110. When two or more alarms are issued at the same time, the alarm with the highest priority level that is set in advance according to the program is selected.

The alarm display section 108 is a block for issuing an instruction to display an alarm as shown in FIG. 4A, 6A, or 7A. When alarm information is received from the input signal alarm detector 104, the alarm display section 108 sends the instruction to display the alarm to the character generator 8. The alarm display section 108 displays the display contents according to the ALARM CODE for a predetermined period of time. For ease of explanation, the character generator 8 and the display driver 9 are not shown in FIG. 3.

The alarm memory 110 is formed with the RAM 4 or the flash memory 5 of FIG. 2, for example, and stores alarm information and the time and time counter value associated with the alarm information. The alarm memory 110 is capable of storing two or more sets of alarm information. In this embodiment, the alarm memory 110 can store up to 100 sets of ALARM CODE/DATE/TC data.

The last alarm display section 112 performs processing to display a last alarm display screen, based on a last alarm display instruction that is sent from the operation unit 11. More specifically, when the key “→” of the operation button 11b of the operation unit 11 is pressed while the cursor 10a is located on “LAST ALARM” as shown in FIG. 4B, the last alarm display section 112 acquires the last issued alarm as the last alarm information from the sets of alarm information recorded in the alarm memory 110. The last alarm display section 112 then sends the last alarm display instruction to the character generator 8. The menu screen shown in FIG. 4B is displayed when an operation button 11a (a menu button) is pressed.

As described above, when an error occurs in the record reproduction device 1, the alarm information associated with the corresponding error occurrence time and time counter value is stored in the alarm memory 110. When a user inputs a last alarm display instruction through the menu screen, the last issued alarm information and the corresponding time and time counter value are displayed on the display 10. Accordingly, even if the user misses the displayed alarm, the user can obtain the information as to the last issued alarm. Further, as the time counter value is displayed as well as the alarm information, so that the user can recognize at which part of the video data the alarm information is generated.

In this embodiment, the information as to the last issued alarm selected from the sets of alarm information stored in the alarm memory is displayed. However, it is also possible to display information other than the information as to the latest alarm. For example, among the alarms issued in the past, the information as to the several latest alarms may be displayed.

It should be understood by those skilled in the art that various modifications, combinations, sub-combinations and alterations may occur depending on design requirements and other factors insofar as they are within the scope of the appended claims or the equivalents thereof.

What is claimed is:

1. An electronic device comprising:
an error detector that detects an error state while video data is being recorded or reproduced;
a time counter value acquiring section that acquires a time counter value of the video data; and
a record processor that causes a recorder to record information as to the error state and the time counter value acquired when the error state is detected, the information and the time counter value being associated with each other.

2. The electronic device according to claim 1, further comprising
a display processor that acquires the information as to the last error state detected and the time counter value associated with the information from the recorder, and performs display processing so as to display the information and the time counter value on a display.

3. The electronic device according to claim 2, wherein the display processor displays display contents in accordance with the information as to the error state on the display for a predetermined period of time when the error detector detects the error state.

4. The electronic device according to claim 1, wherein the record processor records time information as to the detection of the error state in association with information as to the error state and the time counter value.

5. The electronic device according to claim 1, wherein the error detector detects that a video signal or a synchronization signal to be input from an input terminal is not input.

6. A method for displaying an error state, comprising the steps of:
detecting an error state while video data is being recorded or reproduced;
acquiring a time counter value of the video data;
recording information as to the error state in association with the time counter value acquired when the error state is detected; and
reading information as to the last error state detected and the time counter value associated with the information, and displaying the information and the time counter value on a display.

7. The method for displaying an error state according to claim 6, wherein:
the step of recording the information as to the error state includes recording time information as to the detection of the error state in association with the information as to the error state and the time counter value; and
the step of displaying includes displaying the time information, as well as information as to the last error state detected and the time counter value, on the display.
